(19) United States
(12) Patent Application Publication
(10) Pub. No.: US 2013/0099509 A1
(43) Pub. Date: Apr. 25, 2013

(54) HANDLE WITH ADJUSTABLE LATCH CAM

(71) Applicants: WILLIAM S. HANSEN, II, Waukegan, IL (US); Mike Exon, Hainesville, IL (US); Charles Bullock, Waukegan, IL (US)

(72) Inventors: WILLIAM S. HANSEN, II, Waukegan, IL (US); Mike Exon, Hainesville, IL (US); Charles Bullock, Waukegan, IL (US)

(21) Appl. No.: 13/276,746

(22) Filed: Oct. 19, 2011

(51) Int. Cl. E05C 3/14

(52) U.S. Cl. 292/224; 292/197

(57) ABSTRACT

A latch assembly includes a handle and an adjustment member rotatably secured to the handle about a longitudinal axis, but translatably fixed to the handle along the same longitudinal axis. A latch cam is engaged by the adjustment member and is non-rotatably fixed relative to the handle about the longitudinal axis, but translatable relative to the handle along the same longitudinal axis in response to rotation of the adjustment member. Another latch assembly includes a handle with a support member and a securing member disposed in a latch cam. The securing member is moveable between a release position, wherein the latch cam is moveable along the longitudinal axis relative to the support member, and an engaged position, wherein the latch cam is fixed to the support member. Various methods of adjusting the latch assemblies are also provided.

### FIELD OF THE INVENTION

The present invention relates generally to a latching system, and in particular, to a handle with an adjustable latch cam.

### BACKGROUND

Latch systems are often provided with handles, which may be manipulated to move a latch from a latched to an unlatched position. For example, the handle may be coupled to a latch cam that is rotated to engage a frame or other support structure. Typically, the distance between the handle, or a mounting structure supporting the handle, and the latch cam is either fixedly defined, or must be adjusted using multiple tools requiring access to the latch cam. For example, a threaded shaft may be provided, with the latch cam disposed thereon and secured with a pair of nuts and/or washers disposed on opposite sides of the cam. To adjust the position of the cam, one of the nuts must be loosened, the cam moved and the other nut tightened to fix the position of the cam. This can be a time-consuming endeavor that requires specific wrenches sized to engage the nuts. In addition, the nuts may be difficult to access. Accordingly, the need remains for an easy, quick way to adjust the position of a latch cam.

### SUMMARY

The present invention is defined by the following claims, and nothing in this section should be considered to be a limitation on those claims.

In one aspect, one embodiment of a latch assembly includes a handle having a grippable member and a housing with an interior cavity and an opening between an exterior of said handle and the cavity. An adjustment member is disposed within the interior cavity and includes an engagement portion accessible through the opening. The adjustment member is rotatably secured to the handle about a longitudinal axis, but is translatably fixed to the handle along the same longitudinal axis. A latch cam is threadably engaged by the adjustment member. The latch cam is non-rotatably fixed relative to the handle about the longitudinal axis, but is translatable relative to the handle along the same longitudinal axis in response to rotation of the adjustment member. In this way, the longitudinal position of the latch cam can be adjusted relative to the handle, but is thereafter rotatable by the handle.

In another aspect, one embodiment of a latch assembly includes a shaft that is non-rotatably coupled to the handle and extends along the longitudinal axis. The shaft is translatable relative to the handle along the longitudinal axis. An adjustment device is coupled to the shaft and is operable to translate the shaft along the longitudinal axis and to fix the position of the shaft along said longitudinal axis. A cam is coupled to the shaft and extends laterally therefrom.

In yet another aspect, one embodiment of a latch assembly includes a handle rotatable about a longitudinal axis. The handle includes a grippable member and a support member. A latch cam defines a lateral axis substantially perpendicular to the longitudinal axis. A securing member is disposed in the latch cam and extends along the lateral axis. The securing member is moveable between a release position, wherein the latch cam is moveable along the longitudinal axis relative to the support member, and an engaged position, wherein the latch cam is fixed to the support member.

In yet another aspect, one embodiment of a method of adjusting a latch assembly includes providing a handle having a grippable member and a housing having an interior cavity and an opening between an exterior of the handle and the cavity. The method includes rotating an adjustment member disposed within the interior cavity about a longitudinal axis without translating the adjustment member along the longitudinal axis, and threadably engaging a latch cam with the adjustment member and translating the latch cam along the longitudinal axis without rotating the latch cam about the longitudinal axis.

In yet another aspect, one embodiment of a method of adjusting a latch assembly includes providing a handle having a grippable member and a support member defining a longitudinal axis, moving a securing member along a lateral axis transverse to the longitudinal axis to a release position, moving a latch cam along the longitudinal axis when the securing member is in the release position without rotating the latch cam about the longitudinal axis, and moving the securing member to an engaged position with the support member and thereby fixing the latch cam to the support member.

The various embodiments of the latch assemblies, and methods of use thereof, provide significant advantages over other latch assemblies. For example and without limitation, the position of the latch cam can be quickly and easily adjusted. For example and without limitation, a single adjustment member can be manipulated to adjust the position of the latch cam. The adjustment member may be manipulated using a standardized tool, such as s screw driver, rather than having to locate a particular size wrench. Moreover, the adjustment member can be easily accessed, thereby facilitating the adjustment process.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a plan view of one embodiment of a latch assembly.

FIG. 2 is a cross-sectional view of the latch assembly shown in FIG. 1.

FIG. 3 is a perspective view of the latch assembly shown in FIG. 1.

FIG. 4 is a side view of the latch assembly shown in FIG. 1.

FIG. 5 is an exploded view of the latch assembly shown in FIG. 1.

FIG. 6 is a top perspective view of an alternative embodiment of a latch assembly.

FIG. 7 is a bottom perspective view of the latch assembly shown in FIG. 6.

FIG. 8 is an exploded view of the latch assembly shown in FIG. 6.

FIG. 9 is a cross-sectional view of an alternative embodiment of a latch assembly.

FIG. 10 is a partially exploded cross-sectional view of the latch assembly shown in FIG. 9.

FIG. 11 is a perspective view of an alternative embodiment of a latch assembly.

FIG. 12 is an exploded perspective view of the latch assembly shown in FIG. 11.

FIG. 13 is a cross-sectional view of an alternative embodiment of a latch assembly.

FIG. 14 is an exploded view of the latch assembly shown in FIG. 13.

FIG. 15 is an exploded view of an alternative embodiment of a latch assembly.

FIG. 16 is a bottom perspective view of the latch assembly shown in FIG. 15.

FIG. 17 is a perspective view of an alternative embodiment of a latch assembly.

FIG. 18 is an exploded view of the latch assembly shown in FIG. 17.

FIG. 19 is a bottom perspective view of an alternative embodiment of a latch assembly.

FIG. 20 is an exploded top perspective view of the latch assembly shown in FIG. 19.

FIG. 21 is an exploded bottom perspective view of the latch assembly shown in FIG. 19.

FIG. 22 is a perspective view of an alternative embodiment of a latch assembly.

FIG. 23 is a perspective view of a cover for a latch assembly.

FIG. 24 is an exploded perspective view of an alternative embodiment of a latch assembly.

FIG. 25 is a partial exploded view of the latch assembly shown in FIG. 24.

FIG. 26 is a plan view of one embodiment of a latch cam.

FIG. 27 is a side view of the latch cam shown in FIG. 26.

FIG. 28 is a plan view of one embodiment of a latch cam.

FIG. 29 is a side view of the latch cam shown in FIG. 28.

FIG. 30 is a plan view of one embodiment of a latch cam.

FIG. 31 is a side view of the latch cam shown in FIG. 30.

### DETAILED DESCRIPTION OF THE PRESENTLY PREFERRED EMBODIMENTS

It should be understood that the term “plurality,” as used herein, means two or more. The term “longitudinal,” as used herein means of or relating to length or the lengthwise direction, for example of a handle shaft, or assembly thereof. The term “lateral,” as used herein, means directed between or toward (or perpendicular to) the side of the shaft. The term “coupled” means connected to or engaged with, whether directly or indirectly, for example with an intervening member, and does not require the engagement to be fixed or permanent, although it may be fixed or permanent. The term “transverse” means extending across an axis, and/or substantially perpendicular to an axis. It should be understood that the use of numerical terms “first,” “second,” “third,” etc., as used herein does not refer to any particular sequence or order of components; for example “first” and “second” cavities may refer to any sequence of such cavities, and is not limited to the first and second cavities of a particular configuration unless otherwise specified.

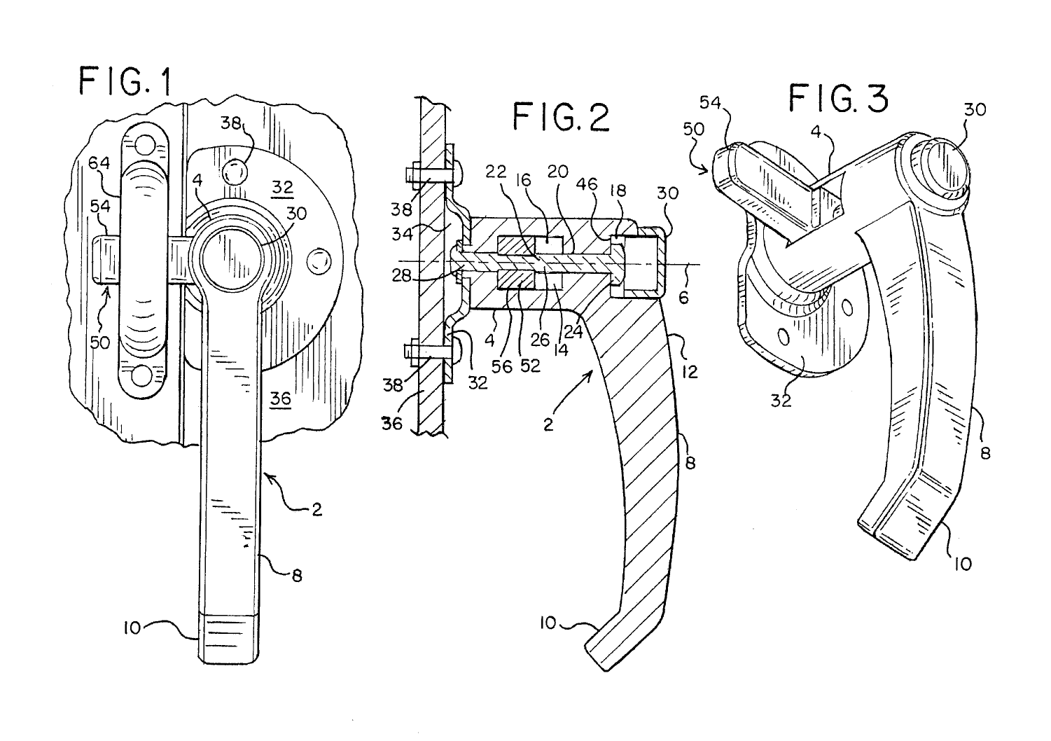

Referring to FIGS. 1-5, 7-10 and 15-16, various embodiments of a latch assembly are shown. The latch assembly includes a handle 2 having a housing 12 with a base 4 defining a longitudinal axis 6 and a grippable member 8 extending laterally from the base and terminating at a free end 10. It should be understood that the housing 12, including the base 4 and grippable member 8, could assume many different shapes and configurations, including a looped member (e.g., D-shaped), a T-shaped grippable member, a ring-like grippable member (circular or otherwise) extending radially from the longitudinal axis, or a grippable member symmetrically formed around the longitudinal axis. The housing 12 has an interior cavity 14, including in one embodiment an enlarged first cavity 16 and an enlarged second cavity 18 communicating with an exterior of the handle, with the cavities connected with a through-hole 20, all aligned along the longitudinal axis 6. In one embodiment, the first cavity 16 is open to the exterior of the handle on opposite sides thereof.

An adjustment member 22 is disposed within interior cavity. In one embodiment, the adjustment member has an engagement portion 24 accessible through the second cavity 18. In one embodiment, the engagement portion 24 is entirely disposed in the second cavity 18 as shown in FIG. 2. For example, in one embodiment, the adjustment member 22 is formed as a bolt or screw, with the engagement portion 24 configured as a head shaped to receive a tool, such as a screw driver, allen wrench, etc. The head 24 may have an internal recess (e.g., slot or socket) shaped to receive the tool, or an external shape (hexagon) configured to be engaged by a tool (box wrench, pliers, etc. The adjustment member 22 further includes a shaft 26 extending through the through hole 20 and into the first cavity 16. An anchor member 28, such as a second fastener, nut, lock washer or clip is coupled to the end of the adjustment member, and in one embodiment secures the handle to a mounting plate 32. The mounting plate 32 may include a raised central flange providing a recess 34 on an opposite side sized to receive a head portion and washer of the anchor member 28 between the mounting plate 32 and support structure 36. The mounting plate 32 may be secured to a door or other support structure 36 with a plurality of fasteners 38.

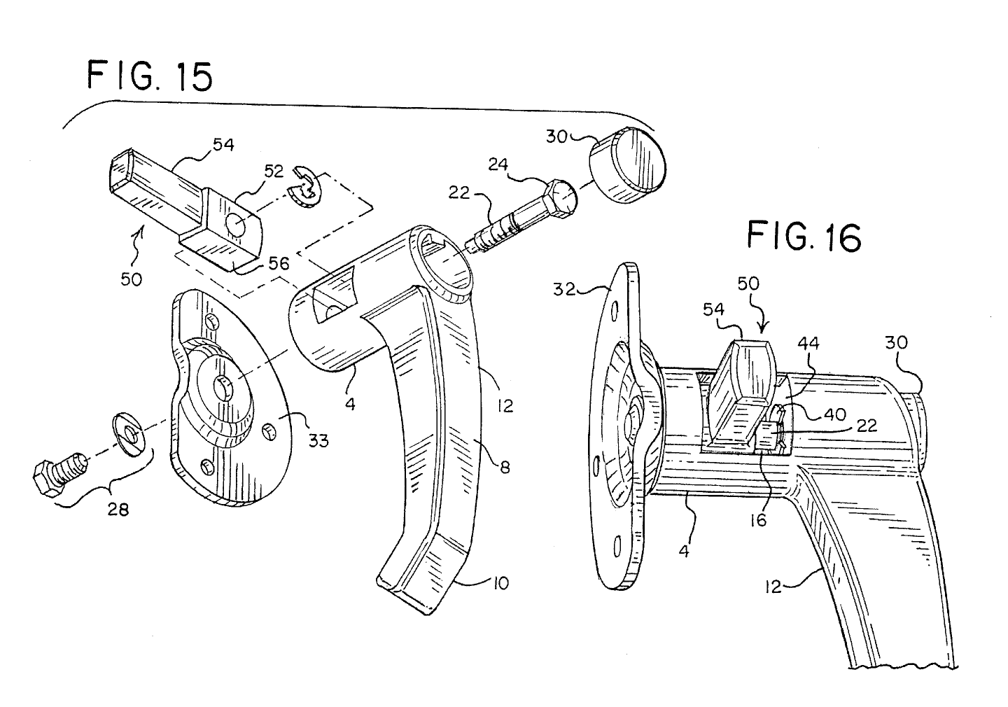

In one alternative embodiment, shown in FIGS. 15 and 16, a clip 40, shown as an e-clip, engages an annular recess or groove 42 on the adjustment member beneath an engagement surface 44 of the first cavity so as to secure the adjustment member to the housing. An anchor member 28 may also be provided to secure the end of the adjustment member to a mounting plate as described above.

The second cavity 18 defines a shoulder or ledge 46 engaging an underside of the head or engagement portion 24, such that the adjustment member 22 is rotatably secured to the handle 2 about the longitudinal axis 6, and is translatably fixed to the handle 2 along the longitudinal axis 6.

A latch cam 50 includes a base portion 52 received in the first cavity 16 and a cam or pawl portion 54 extending laterally therefrom from the base through the side openings. The base portion 52 is configured with side walls 56 that engage the sides of the openings to the cavity 16 so as to be non-rotatable relative the housing. The base portion 52 of the latch cam is threadably engaged by the adjustment member 22. As the adjustment member 22 is rotated, the latch cam 50 is thereby translated in the first cavity 16 along the longitudinal axis 6 without being rotated due to the interface between the base portion and the sides of the openings to the cavity 16. A plug member 30, or cover, may be inserted into or over the second cavity 18 to cover or obscure the adjustment member 22 and in particular the engagement portion 24 thereof so as to protect the adjustment member from the elements and to improve the aesthetics of the assembly. A slot 31 may be provided in the cover to provide a location to engage the cover with a tool, which may be used to pry the cover away from the handle.

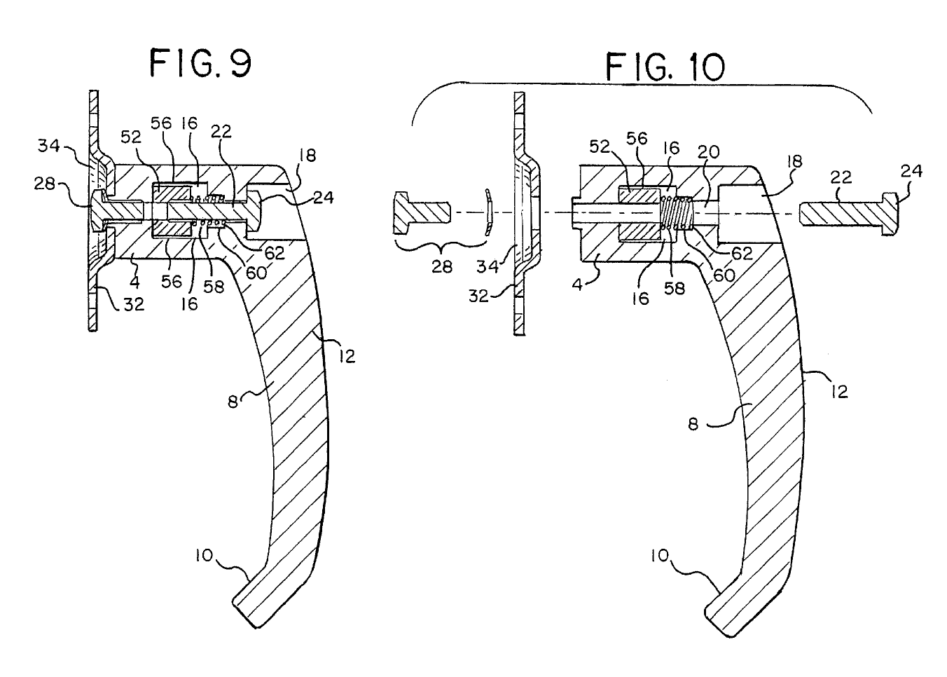

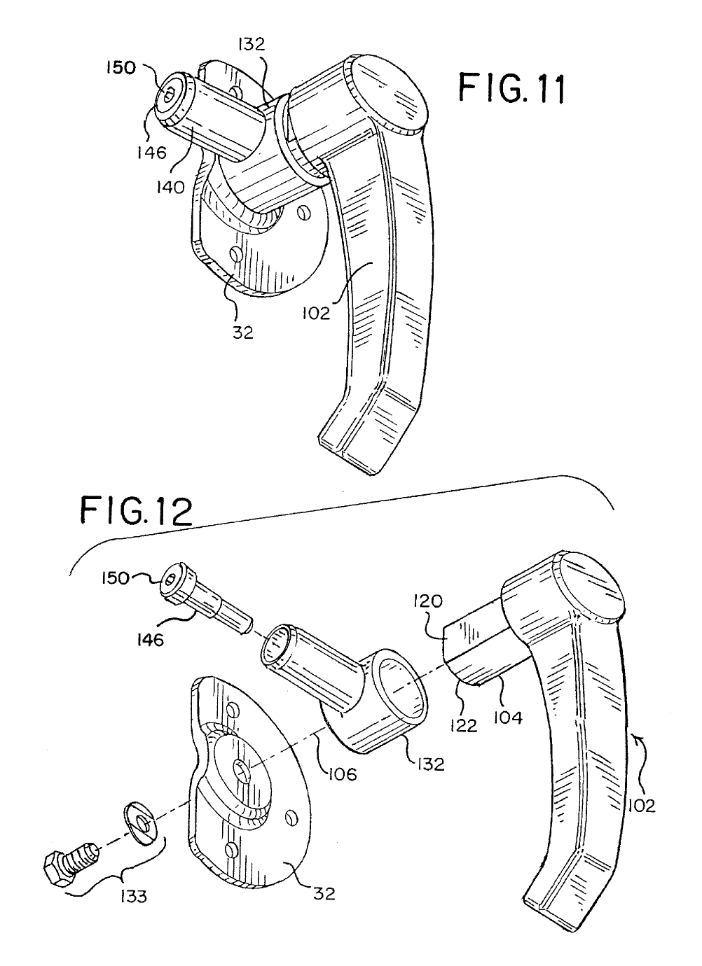

In one embodiment, shown in FIGS. 9 and 10, a biasing member 58, such as a compression spring, elastomeric member, cantilever spring, tension spring, Belleville washer, etc., may be disposed in the first cavity so as to bias the cam portion away from the engagement member. A recess 60 with a shoulder or ledge 62 may be formed along the through-hole 20 to receive and engage one end of the biasing member 58.

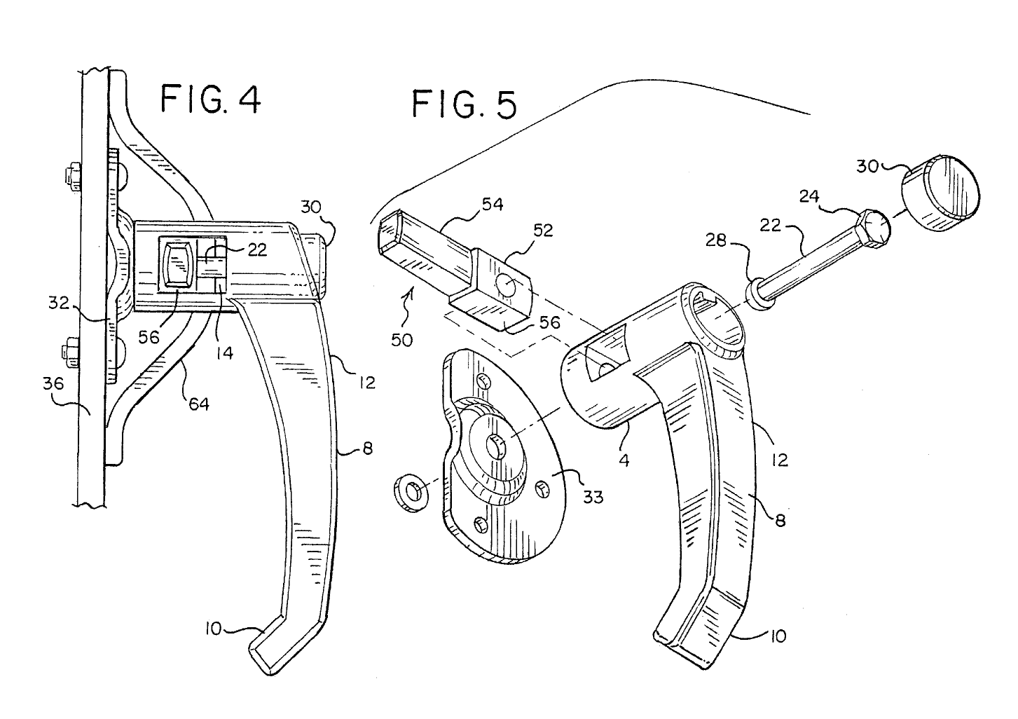

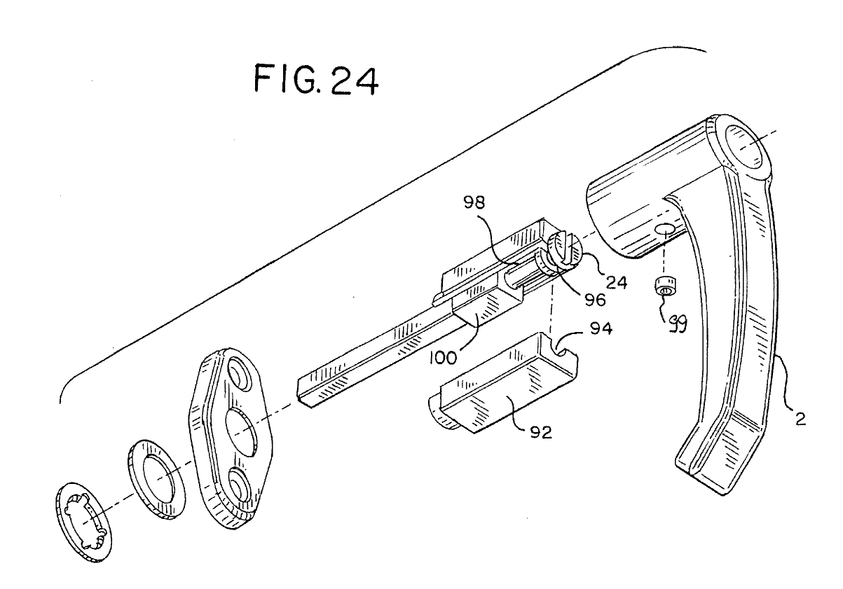

As shown in FIGS. 1-5, the latch cam 50 is disposed between the handle 2 and the mounting plate 32. For example, as shown FIGS. 1 and 4, the mounting plate 32 may be mounted to a surface of a support structure 36 such as a door (or adjacent frame/wall) with the cam portion 54 disposed under and engaging a catch member 64 secured to the other of the adjacent support structure. It should be understood, however, that in other embodiments the mounting plate (and door) may be disposed between the handle and the latch cam, for example where the latch cam is engaging an interior catch or surface (i.e., opposite the surface that the handle extends from) of an adjacent support structure as shown for example in FIG. 24.

Referring to FIGS. 27-31, various latch cams 200, 204, 212 are shown, each configured with a cam portion 208, 210, 214 and a pair of openings 202, 206, 216. The openings may be used to rotationally secure additional latch arms (not shown) that extend therefrom to provide additional two or three point latching.

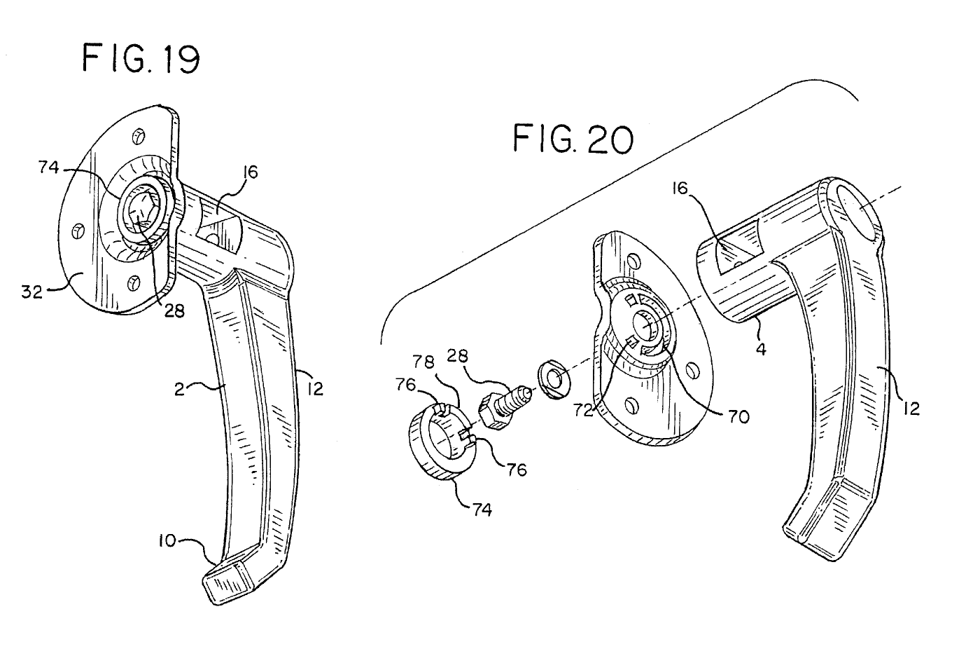

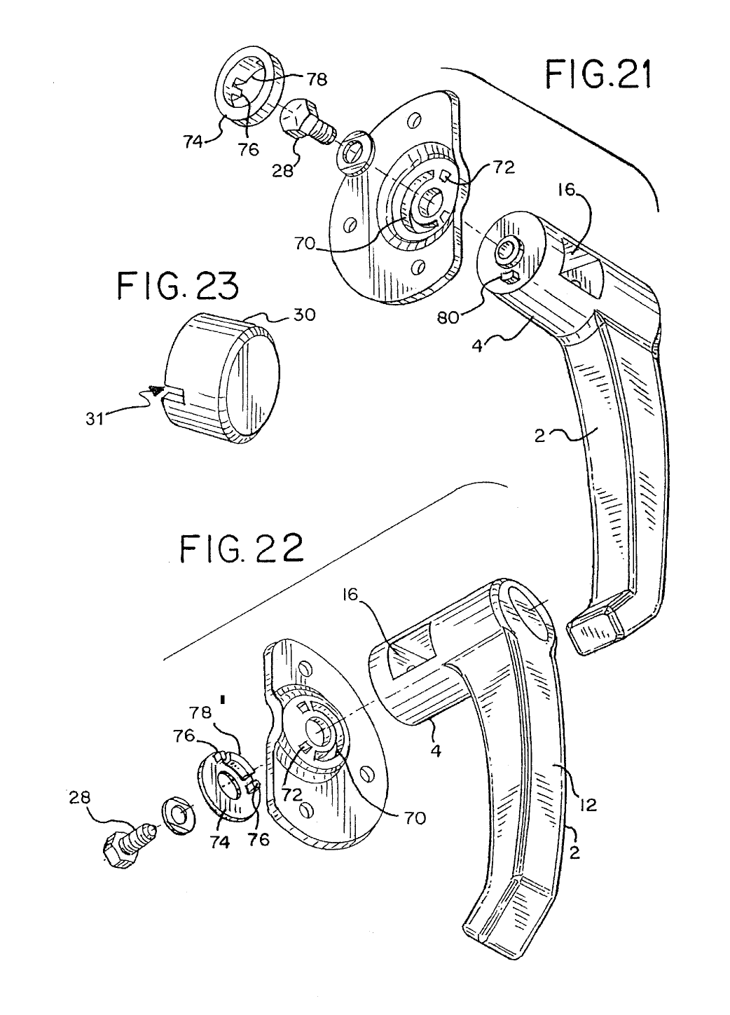

In the embodiments shown, the handle 2 may rotate 360° about the longitudinal axis 6. In the embodiment shown in FIGS. 19-22, the mounting plate 32 is provided with a track 70 that defines the range of rotation and a pair of key holes 72. A stop member 74 has a corresponding pair of opposite key members 76, one of which is disposed in one of the key holes 72, and an annular stop member 78 that is disposed in the track 70 to limit the amount of rotation. The bottom of the handle housing base 4 is configured with a guide 80 that moves in the track 70. The stop member 74 can be positioned with either of the key members 76 in one of the key holes 72, and the stop member 78 and other key member 76 limiting the range of rotation of the handle by engaging the guide 80. For example, as shown, the stop member 74 can be positioned in either of a right or left hand configuration so as to limit the rotation travel of the handle to 90° in either the left or right hand direction respectively. Conversely, the stop member may be removed entirely, with the guide 80 moving in the track 70, and limited by the two ends of the track, e.g., at 180° rotational movement. Of course, it should be understood that the annular length of the stop member, or track may be configured to limit the range of rotation to other angles. The stop member 74 is disposed in the recess 34 between the mounting plate and the support structure

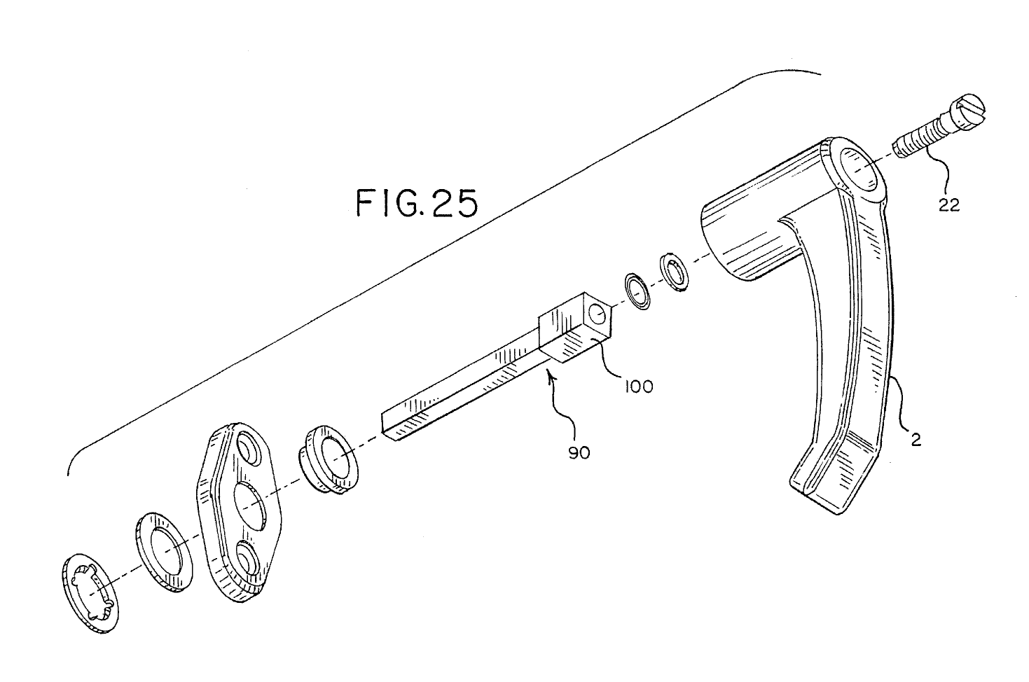

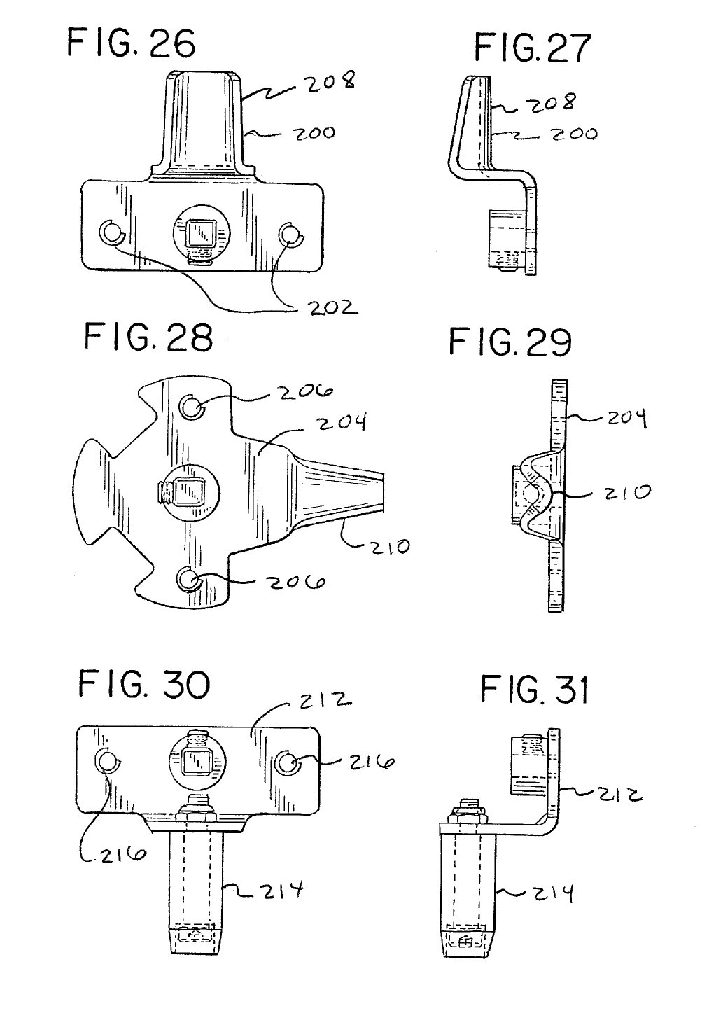

Referring to FIGS. 24 and 25, the latch cam includes an adjustment shaft 90 extending along the longitudinal axis 6 and having an end portion threadably engaged by the adjustment member 22. A cam portion (shown for example in FIGS. 27-31) is fixedly secured to and extends laterally from the adjustment shaft. An insert member 92 is disposed in the interior cavity of the handle. The insert member 92 has a lip portion 94 rotatably engaging a groove 96 formed adjacent an end portion 24 of the adjustment member 22. The insert member 92 further defines an interior cavity 98 forming a track. The adjustment shaft has a guide portion 100 slidably and non-rotatably moveable along the track 98. A set screw 99 may be provided to secure the insert member 92 to the inside of the handle. Alternatively, or in combination, the inset member may be bonded with adhesive or ultrasonically welded to the handle.

In operation, a user removes the cover 30 and rotates the adjustment member 22, which in turn engages and translates the latch cam 50 to a desired location, e.g., such that the cam portion 54 is properly positioned to engage an adjacent support structure such as a catch member 64 secured to an adjacent frame or panel. Alternatively, the adjustment member 22 moves/translates the adjustment shaft 90, and attached cam portion. After the cam portion is adjusted, the cover 30 may be replaced to again obscure the engagement portion of the adjustment member.

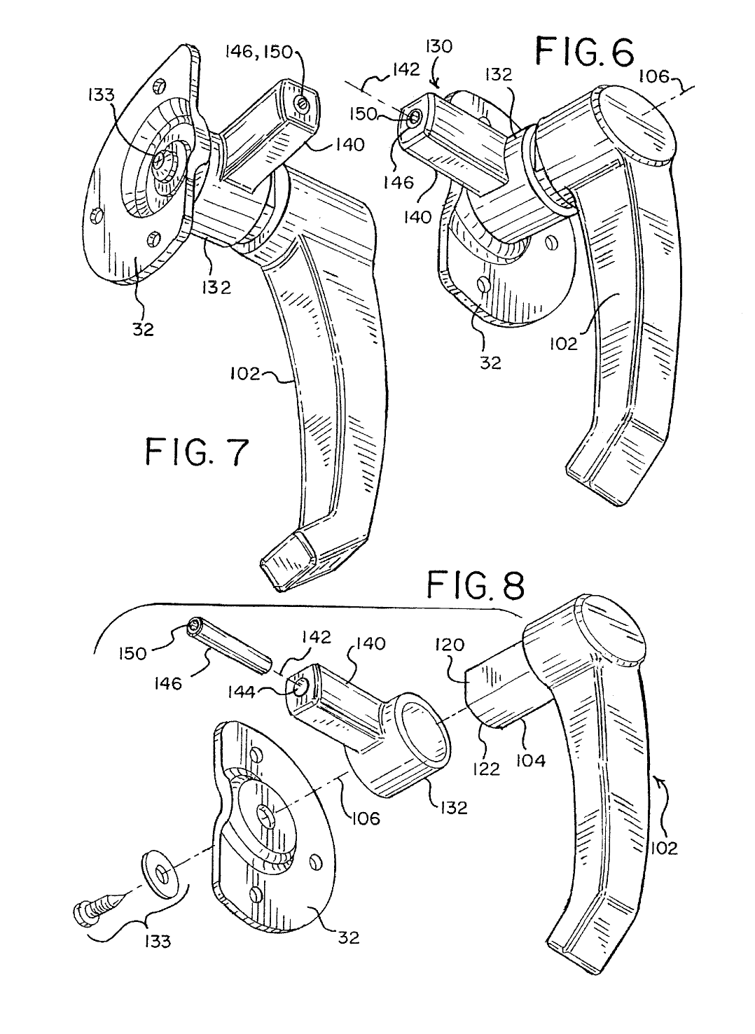

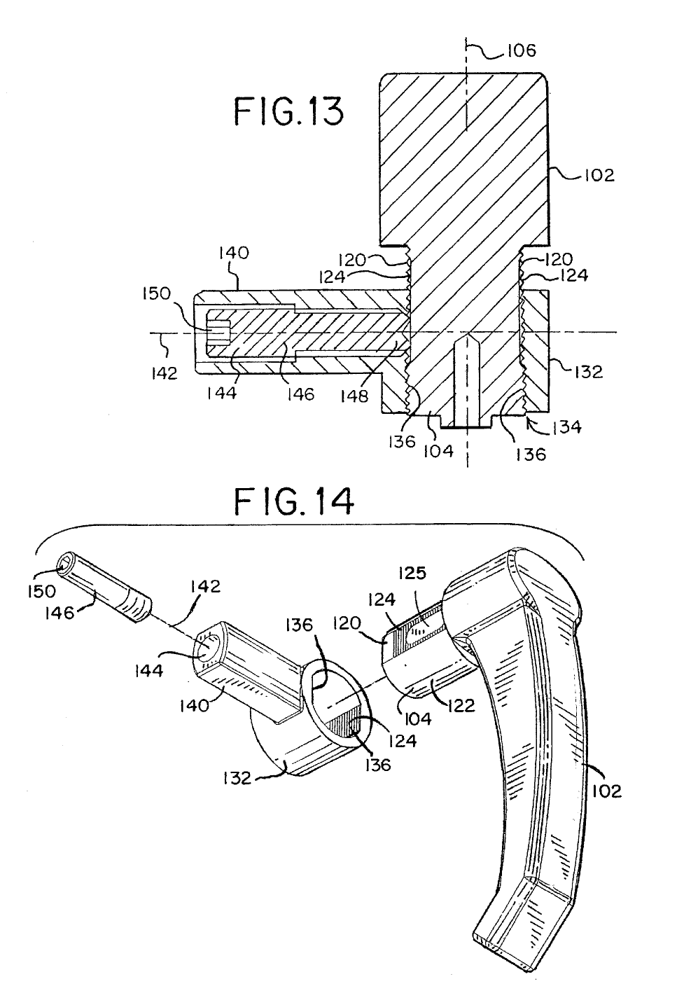

Referring to FIGS. 6-8 and 11-14, another embodiment of a latch assembly includes a handle 102 rotatable about a longitudinal axis 106. A support member 104, shown as a boss or post member, extends along the longitudinal axis. The support member 104 has at least one flat side wall 120, and in one embodiment, opposite flat side walls joined by curved walls 122. In one embodiment, shown in FIG. 13, the flat walls are configured with a plurality of teeth 124 spaced along the longitudinal direction 106, with a central smooth portion 125 positioned to be engaged by a securing member. A latch cam 130 is non-rotatably fixed to the support member 104. In one embodiment, the latch cam includes an annular collar 132 having a through opening 134 shaped to receive the boss, with a pair of opposing flat interior walls 136, such that the opening forms a socket that mates with the post to prevent relative rotation therebetween. The latch cam may be mounted on the post in one of two positions, with a cam portion 140 extending radially from either side of the support member. The walls 136 of the collar may be formed with a plurality of teeth 124 having the same spacing or pitch as the teeth on the boss. An anchor member 133, configured in one embodiment as a screw and washer, rotatably secures the support member 104 to the mounting plate 32.

The cam portion 140 extends laterally from the collar 132 along a lateral axis 142 substantially perpendicular to the longitudinal axis 106. The cam portion may have a cylindrical shape, as shown in FIGS. 11, 12 and 14, or may have a more rectangular cross section (with curved or convex outer surfaces) as shown in FIGS. 6-8. An opening 144 extends through an interior of the cam portion. A securing member 146 is disposed in the opening and extends along the lateral axis 142. An end portion 148 of the securing member engages the support member 104, and in particular surface 125, to secure the position of the latch cam 130 relative to the support member 104. In one embodiment the securing member 146 threadably engages the cam portion 140, with an end portion 150 that may be engaged and manipulated by a tool. In one embodiment, the securing member 146 may be configured as a set screw. The securing member 146 may be moved along the lateral axis 142 from a release position, where it is disengaged from the support member 104, and an engaged position, wherein it engages the support member. In the engaged position, the securing member 146 further draws the latch cam 130 against the support member 104, such that opposing teeth 124 on the flat surfaces are engaged, further securing the latch cam against longitudinal movement.

In operation, the user loosens the securing member 146, or moves the securing member to the release position, whereinafter the latch cam 130 can moved longitudinally along the support member 104 to a desired location. The securing member 146 is then tightened, or moved to the engaged position, such that the teeth 124 are engaged and the latch cam is secured to the support member 104.

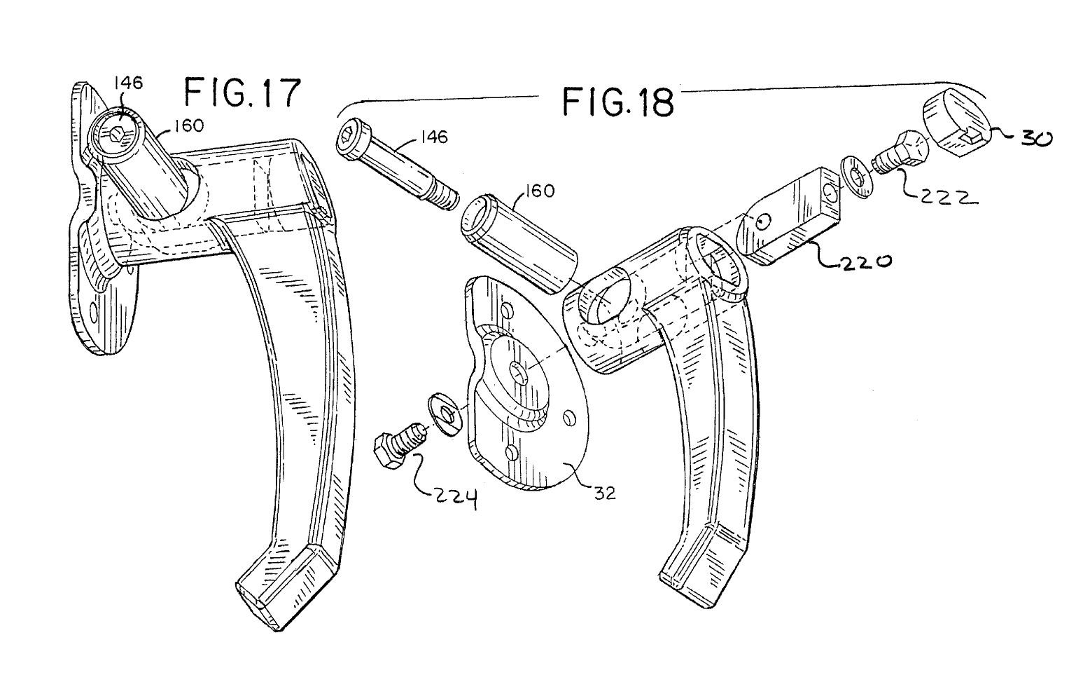

In one embodiment, shown in FIGS. 17 and 18, the latch cam includes a roller 160 defining the exterior surface of the cam portion. The roller 160 is rotatable about the lateral axis 142, and may roll when engaged with a frame or other structure, thereby reducing the friction force required to close the latch. In this embodiment, the cam portion is coupled to an adjustment member 220 with a securing member 146, with the cam portion extending through an opening in the base 4 of the handle housing. The adjustment member 220 is threadably engaged with an adjustment screw 222 at one end, and is engaged at the other end with a secondary adjustment screw 224, which bears against the end of the adjustment member. The screws 22, 224 may be adjusted to change the position of the adjustment member 220, and the cam roller 160 connected thereto.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A latch assembly comprising:
a handle comprising a grippable member and a housing having an interior cavity and an opening between an exterior of said handle and said cavity;
an adjustment member disposed within said interior cavity, said adjustment member having an engagement portion accessible through said opening, wherein said adjustment member is rotatably secured to said handle about a longitudinal axis, and wherein said adjustment member is translatably fixed to said handle along said longitudinal axis; and
a latch cam threadably engaged by said adjustment member, wherein said latch cam is non-rotatably fixed relative to said handle about said longitudinal axis, and wherein said latch cam is translatable relative to said handle along said longitudinal axis in response to rotation of said adjustment member.

2. The latch assembly of claim 1 wherein said opening comprises a first opening, and wherein said housing comprises a second opening in a side of said housing and communicating with said interior cavity, wherein at least a portion of said latch cam extends laterally through said second opening.

3. The latch assembly of claim 1 further comprising a removable cover moveable from an engaged position wherein said cover closes said opening in said housing so as to obscure said engagement portion and a disengaged position wherein said cover is spaced from said opening such that said engagement portion is visible and accessible through said opening.

4. The latch assembly of claim 1 wherein said latch cam further comprises an adjustment shaft extending along said longitudinal axis and having an end portion threadably engaged by said adjustment member, and a cam portion extending laterally from said adjustment shaft.

5. The latch assembly of claim 4 wherein said housing further comprises an insert member disposed in said handle, wherein said insert portion comprises a lip portion rotatably engaging an end portion of said adjustment member and a track, wherein said adjustment shaft comprises a guide portion slidably and non-rotatably moveable along said track.

6. The latch assembly of claim 1 further comprising a mounting plate, wherein said latch cam is disposed between said mounting plate and said handle.

7. The latch assembly of claim 1 wherein said latch cam comprises a roller rotatable about a lateral axis extending substantially perpendicular to said longitudinal axis.

8. The latch assembly of claim 1 further comprising a spring disposed between said housing and said latch cam and biasing said latch cam away from said handle.

9. A latch assembly comprising:
a handle rotatable about a longitudinal axis, said handle comprising a grippable member and a housing;
a shaft non-rotatably coupled to said handle and extending along said longitudinal axis, wherein said shaft is translatable relative to said handle along said longitudinal axis;
an adjustment device coupled to said shaft and operable to translate said shaft along said longitudinal axis and to fix the position of said shaft along said longitudinal axis; and
a cam coupled to said shaft and extending laterally therefrom.

10. The latch assembly of claim 9 wherein said adjustment device is threadably engaged with said shaft.

11. The latch assembly of claim 9 wherein said handle comprises a track and said shaft comprises a guide slideable within said track.

12. A latch assembly comprising:
a handle rotatable about a longitudinal axis, said handle comprising a grippable member and a support member;
a latch cam defining a lateral axis substantially perpendicular to said longitudinal axis; and
a securing member disposed in said latch cam and extending along said lateral axis, said securing member moveable between a release position, wherein said latch cam is moveable along said longitudinal axis relative to said support member, and an engaged position, wherein said latch cam is fixed to said support member.

13. The latch assembly of claim 12 wherein said latch cam comprises a roller defining a latch engaging outer surface of said latch cam.

14. The latch assembly of claim 12 wherein said support member comprises a plurality of teeth spaced apart along a longitudinal direction thereof, and wherein said latch cam comprises at least one tooth engaged with at least some of said plurality of teeth when said securing member is moved to said engaged position.

15. The latch assembly of claim 12 wherein said latch cam is non-rotatably fixed to said support member about said longitudinal axis when said securing member is in either of said release or engaged positions.

16. The latch assembly of claim 12 wherein said support member comprises a post having a flat portion engaged by said securing member.

17. The latch assembly of claim 12 wherein said latch cam comprises an annular collar surrounding said support member.

18. A method of adjusting a latch assembly comprising:
providing a handle comprising a grippable member and a housing having an interior cavity and an opening between an exterior of said handle and said cavity;
rotating an adjustment member disposed within said interior cavity about a longitudinal axis without translating said adjustment member along said longitudinal axis; and
threadably engaging a latch cam with said adjustment member and translating said latch cam along said longitudinal axis without rotating said latch cam about said longitudinal axis.

19. The method of claim 18 further comprising covering said opening and thereby obscuring said adjustment member.

20. A method of adjusting a latch assembly comprising:
providing a handle comprising a grippable member and a support member defining a longitudinal axis;
moving a securing member along a lateral axis transverse to said longitudinal axis to a release position;
moving a latch cam along said longitudinal axis when said securing member is in said release position without rotating said latch cam about said longitudinal axis, said latch cam extending along said lateral axis; and
moving said securing member to an engaged position with said support member and thereby fixing said latch cam to said support member.

21. The method of claim 20 wherein said support member and said latch cam comprise mating teeth, and wherein said moving said securing member to said engaged position comprising engaging said mating teeth.
